(19) United States
(12) Patent Application Publication
(10) Pub. No.: US 2026/0079066 A1
(43) Pub. Date: Mar. 19, 2026

(54) DETECTION UNIT AND DETECTION DEVICE

(71) Applicant: SHENZHEN ENVICOOL TECHNOLOGY CO., LTD., Shenzhen City (CN)

(72) Inventors: CHENGSHENG SONG, Shenzhen City (CN); XIANWEN REN, Shenzhen City (CN)

(73) Assignee: SHENZHEN ENVICOOL TECHNOLOGY CO., LTD., Shenzhen City (CN)

(21) Appl. No.: 19/398,031

(22) Filed: Nov. 23, 2025

Related U.S. Application Data
(63) Continuation of application No. PCT/CN2024/127384, filed on Oct. 25, 2024.

(30) Foreign Application Priority Data
Oct. 26, 2023 (CN) 202311403121.6

(51) Int. Cl. G01M 3/16

(52) U.S. Cl. CPC G01M 3/16

(57) ABSTRACT

A detection unit includes a first detection module including a first electrode layer, a first insulating layer and a second electrode layer stacked in sequence. The first insulating layer defines a first through hole, the first electrode layer at least partially covers the first through hole, and the second electrode layer and the first electrode layer are staggered. When liquid drips onto the second electrode layer and flow into the first through hole, the first electrode layer and the second electrode layer are electrically connected by the liquid. Thus, a controller can detect the liquid leakage. The first detection module has a sheet-like structure, and the size of the first detection module is adjustable according to actual conditions to achieve a wide coverage and adapt to more application scenarios, thereby solving the problem of a high requirement for matching between a conventional liquid leakage detection sensor and a detected scenario.

### CROSS REFERENCE TO RELATED APPLICATION

The present disclosure is a continuation application of PCT application No. PCT/CN2024/127384 filed on October 25, 2024, which claims priority of Chinese patent application No. 202311403121.6, entitled “Detection Unit and Detection Device”, filed with the China National Intellectual Property Administration on October 26, 2023. All of the above are hereby incorporated by reference in their entirety.

### FIELD

The present disclosure relates to the technical field of liquid detection sensors and, in particular, to a detection unit and a detection device.

### BACKGROUND

A liquid leakage detection sensor is a sensor used to detect whether there is liquid leakage in a scenario to be detected, and it usually works for detection based on the working principle of liquid conductivity.

A liquid leakage detection sensor usually includes two electrode layers and a water-absorbing layer arranged between the two electrode layers. When liquid leakage occurs, the water-absorbing layer absorbs liquid and becomes electrically conductive, thus connecting the two electrode layers. However, there exist following problems in the prior art:

1. If less liquid leaks, the water-absorbing layer may not be completely wetted, resulting in failure to obtain liquid leakage information in time.

2. If the air humidity is high, the humid air will also wet the water-absorbing layer and make the water-absorbing layer electrically conductive, causing the leakage sensor to give a false alarm.

3. The water-absorbing layer needs to be completely covered by the electrode layers, resulting in use of more materials for the electrode layers and high cost.

### SUMMARY

It is desired to provide an improved detection unit and a detection device.

In one aspect, the present disclosure provides a detection unit which includes a first detection module, wherein the first detection module includes a first electrode layer, a second electrode layer and a first insulating layer. The first electrode layer, the first insulating layer and the second electrode layer are stacked in sequence. The first insulating layer defines a first through hole, the first electrode layer at least partially covers the first through hole, and the second electrode layer is offset from the first through hole. Thus, the projections of the first electrode layer and the second electrode layer on the first insulating layer is not overlapped within the boundary of the first through hole.

In some embodiments, the first detection module further comprises a second insulating layer which is connected to a side of the second electrode layer away from the first insulating layer, the second insulating layer defines a second through hole and a third through hole which are spaced apart, the second through hole and the first through hole are arranged correspondingly from top to bottom, and the second electrode layer covers at least part of the third through hole.

In some embodiments, the first detection module further comprises a third insulating layer which is connected to a side of the first electrode layer away from the first insulating layer and covers the first electrode layer. Preferably, the side of the first electrode layer away from the first insulating layer is fully covered by the third insulating layer.

In some embodiments, the first detection module further comprises a first conductive portion and a second conductive portion. The first conductive portion has one end serving as a first wiring end and the other end serving as a first connecting end, and the first connecting end is connected to the first electrode layer. The second conductive portion has one end serving as a second wiring end and the other end serving a second connecting end, and the second connecting end is connected to the second electrode layer. The second conductive portion is offset from the first through hole, or, the second conductive portion is covered with a fourth insulating layer.

In some embodiments, a plurality of first wiring ends and a plurality of second wiring ends are provided, and the first wiring ends and the second wiring ends are arranged in one-to-one correspondence, all the first wiring ends are arranged along a peripheral side of the first electrode layer and spaced apart from each other, and all the second wiring ends are arranged along a peripheral side of the second electrode layer and spaced apart from each other.

In some embodiments, any one of the first wiring ends and any one of the second wiring ends do not overlap each other in the first direction.

In some embodiments, the first insulating layer is provided with first notches corresponding to the first wiring ends; the second insulating layer is provided with second notches corresponding to the first wiring ends and third notches corresponding to the second wiring ends.

In some embodiments, the detection unit further comprises a second detection module, wherein the second detection module and the first detection module are stacked. The second detection module comprises a plurality of sensors, each sensor has a detection parameter, and all the detection parameters are the same or different.

In some embodiments, the second detection module further comprises isolating layers which cover the sensors.

In another aspect, the present invention further provides a detection device which comprises a plurality of said detection units described above.

In further another aspect, the present invention further provides a detection unit which comprises a first detection module. The first detection module comprises a first electrode layer, a second electrode layer and a first insulating layer. The first electrode layer, the first insulating layer and the second electrode layer are stacked in sequence in a first direction, i.e., the first electrode layer being located at one side of the first insulating layer while the second electrode layer being located at an opposite side of the first insulating layer. The first insulating layer defines a first through hole. The first electrode layer covers at least part of the first through hole, i.e., the first electrode layer is overlapped with at least part of the first through hole in the first direction. The second electrode layer at least partly exposes the first through hole such that liquid dripping onto the second electrode layer can flows through the first through hole to contact the first electrode layer.

A detection unit of the present disclosure includes a first detection module, wherein the first detection module includes a first electrode layer, a second electrode layer and a first insulating layer. The first electrode layer, the first insulating layer and the second electrode layer are stacked in sequence. The first insulating layer defines a first through hole, the first electrode layer at least partially covers the first through hole, and the second electrode layer and the first through hole are staggered.

The working principle of the detection unit of the present disclosure is as follow: during arrangement, one side of the first detection module, at which the second electrode layer is arranged, faces the scenario to be detected. When there is liquid leakage in the scenario to be detected, the liquid will drip onto the second electrode layer and flow on the second electrode layer. When the liquid flows into the first through hole, the first electrode layer and the second electrode layer are connected to form a circuit by virtue of the liquid, and current flows between the first electrode layer and the second electrode layer. In this case, an external controller can obtain information about the presence of liquid leakage in the detected scenario.

In the detection unit of the present disclosure, because the first insulating layer is provided with the first through hole, when the liquid dripping onto the second electrode layer flows through the first through hole and contacts the first electrode layer, the liquid can connect the first electrode layer and the second electrode layer. When current following between the first electrode layer and the second electrode layer is detected by the external controller, it can be determined that there is liquid leakage in the detected scenario. Compared with the prior art, because the water-absorbing layer used as an intermediate medium is omitted, the connection between the first electrode layer and the second electrode layer is not be affected by the water absorption of the water-absorbing layer, and the failure to trigger an alarm due to leakage of less liquid or a false alarm due to excessive humidity of the air can be avoided.

Furthermore, the first electrode layer and the second electrode layer are at least partially staggered. That is, in the first direction, the first electrode layer and the second electrode layer are at least partially not overlapped with each other, so as to save the materials used for the first electrode layer and the second electrode layer. For example, the first electrode layer only covers the first through hole, and the second electrode layer covers the first insulating layer other than the first through hole. In this way, without affecting the detection results, the materials used for the first electrode layer and the second electrode layer can be saved to the greatest extent, thereby reducing the cost.

### BRIEF DESCRIPTION OF THE DRAWINGS

In order to more clearly illustrate the technical solutions in the embodiments of the present disclosure or the prior art, the drawings required for the description of specific embodiments and the prior art will be introduced briefly. Obviously, the drawings described below are only some embodiments of the present disclosure. Those of ordinary skill in the art can obtain other drawings based on these drawings without creative labor.

FIG. 1 is a schematic structural diagram of an upper surface of a first detection module according to an embodiment of the present disclosure;

FIG. 2 is a schematic structural diagram of a lower surface of the first detection module according to an embodiment of the present disclosure;

FIG. 3 is an exploded view of the first detection module according to an embodiment of the present disclosure;

FIG. 4 is a schematic structural diagram of a first electrode layer according to an embodiment of the present disclosure;

FIG. 5 is a schematic structural diagram of a second electrode layer according to an embodiment of the present disclosure;

FIG. 5A illustrates an electrical connection between the detection unit and a controller;

FIG. 6 is a schematic structural diagram of a second insulating layer according to an embodiment of the present disclosure;

FIG. 7 is a schematic structural diagram of a first insulating layer according to an embodiment of the present disclosure;

FIG. 8 is a schematic structural diagram of a detection device according to an embodiment of the present disclosure, where a plurality of first detection modules is spliced together; and

FIG. 9 is a schematic structural diagram of an assembly of a first detection module and a second detection module according to an embodiment of the present disclosure.

### REFERENCE NUMERALS:

1-first detection module; 11-first electrode layer; 12-second electrode layer; 13-first insulating layer; 131-first through hole; 132-first notch; 14-second insulating layer; 141-second through hole; 142-third through hole; 143-second notch; 144-third notch; 15-third insulating layer; 16-first conductive portion; 161-first connecting end; 162-first wiring end; 17-second conductive portion; 171-second connecting end; 172-second wiring end;

2-second detection module; 21-sensor.

### DESCRIPTION OF THE EMBODIMENTS

The technical solution of the present disclosure will be described clearly and completely below in conjunction with embodiments, and it will be apparent that the embodiments described herein are merely some, not all of the embodiments of the present disclosure. Based on the embodiments of the present disclosure, all other embodiments obtained by those of ordinary skill in the art without creative work fall within the scope of the present disclosure.

The present disclosure provides a detection unit. The detection unit is arranged in a detected scenario and configured to detect in real time whether there is liquid leakage in the detected scenario.

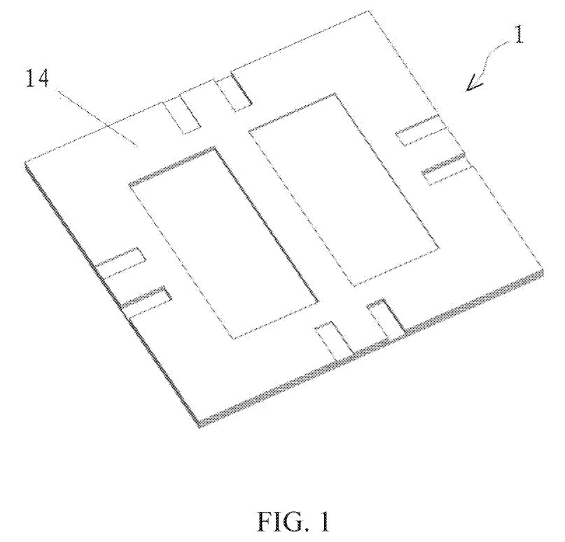

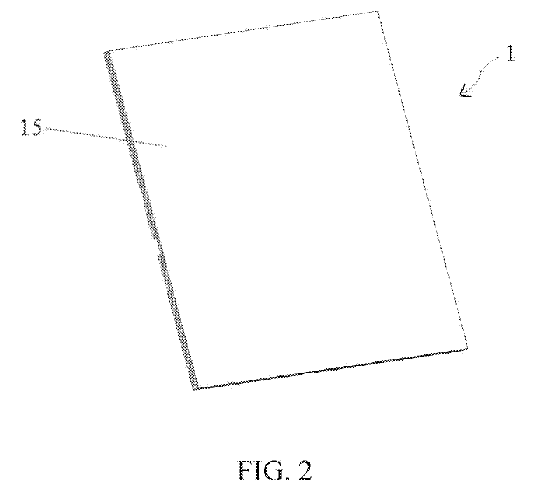

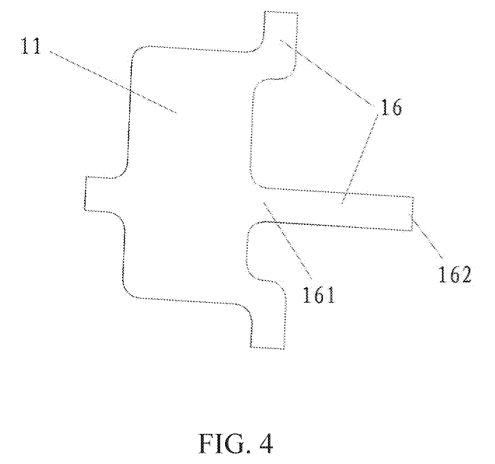

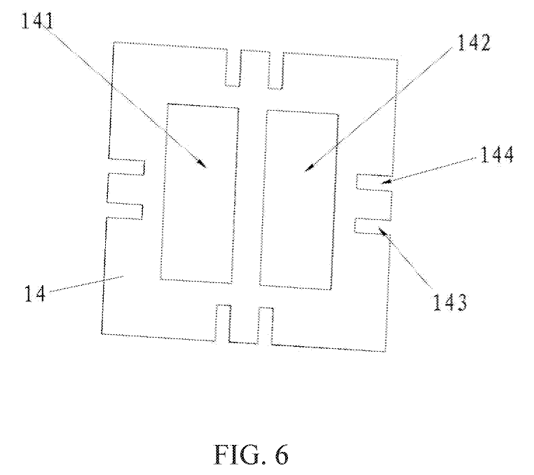

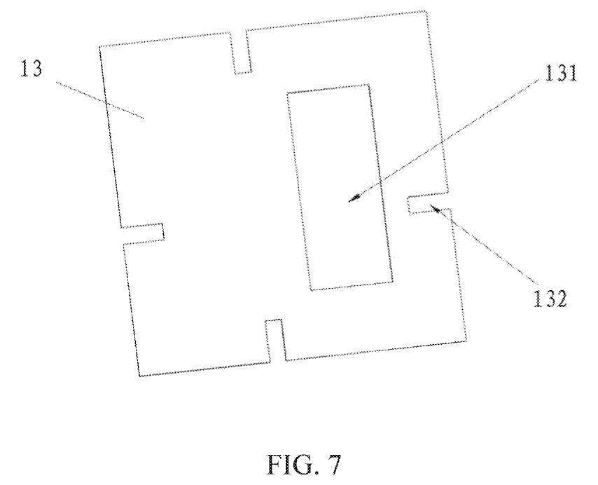

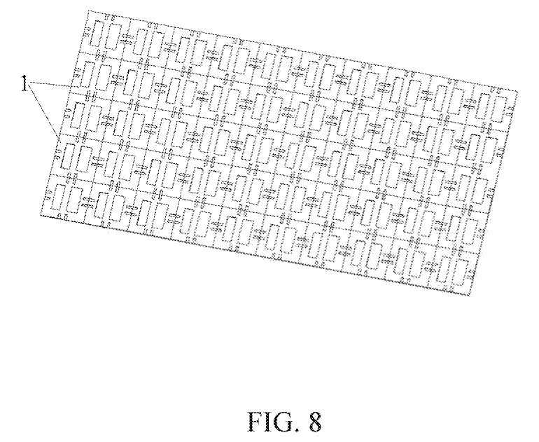

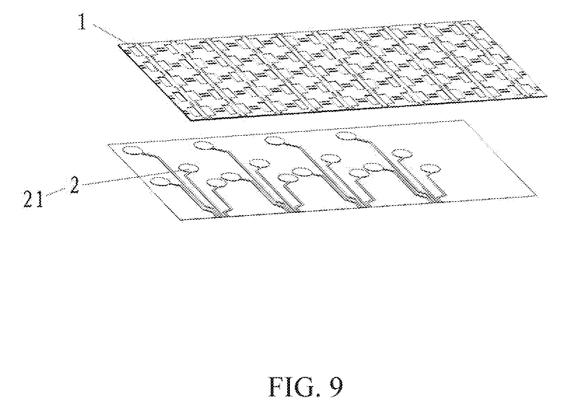

As shown in FIGS. 1-9, a detection unit according to an embodiment of the present disclosure includes a first detection module 1 which includes a first electrode layer 11, a second electrode layer 12, a first insulating layer 13 and a second insulating layer 14. The first electrode layer 11, the first insulating layer 13, the second electrode layer 12 and the second insulating layer 14 are stacked in sequence, and the first insulating layer 13 and the second insulating layer 14 are at least partially staggered in a first direction. The first insulating layer 13 defines a first through hole 131, the first electrode layer 11 covers at least part of the first through hole 131, and the second electrode layer 12 does not cover the first through hole 131, so that the second electrode layer 12 exposes at least part of the first through hole 131.

In this embodiment, the detection unit includes a first detection module 1 which is configured to detect whether there is liquid leakage in a detected scenario.

For ease of description, the end of the first detection module 1 provided with the first electrode layer 11 is defined as a lower end, and the end provided with the second electrode layer 12 is defined as an upper end.

In this embodiment, the first detection module 1 includes a first electrode layer 11, a second electrode layer 12 and a first insulating layer 13. The first electrode layer 11 and the second electrode layer 12 are both made of conductive materials, such as copper, aluminum or some other conductive alloys. The first insulating layer 13 is made of an insulating material, such as PET (polyethylene terephthalate), PI (polyimide), TPU (thermoplastic polyurethane elastomer), PVC (polyvinyl chloride) or FEP (fluorinated ethylene propylene copolymer).

During assembly, the first electrode layer 11, the first insulating layer 13 and the second electrode layer 12 are stacked in sequence. That is, the first insulating layer 13 is attached to an upper surface of the first electrode layer 11, and the second electrode layer 12 is attached to an upper surface of the first insulating layer 13. The first insulating layer 13 is arranged between the first electrode layer 11 and the second electrode layer 12, no overlap is formed between the projections of the first electrode layer 11 and the second electrode layer 12 on the first insulating layer 13 within the boundary of the first through hole 131, and the first insulating layer 13 acts as an insulating member to prevent a closed circuit being formed between the first electrode layer 11 and the second electrode layer 12.

In this embodiment, the areas of the first electrode layer 11 and the second electrode layer 12 are both smaller than the area of the first insulating layer 13. That is, part of the lower surface of the first insulating layer 13 is not covered by the first electrode layer 11, and part of the upper surface of the first insulating layer 13 is not covered by the second electrode layer 12.

In this embodiment, the first insulating layer 13 defines a first through hole 131. The first through hole 131 is formed in the area of the first insulating layer 13 that is not covered by the second electrode layer 12, so that the first electrode layer 11 is partially exposed from the first through hole 131, and the second electrode layer 12 does not cover the first through hole 131. In this way, the projections of the first electrode layer 11 and the second electrode layer 12 on the first insulating layer 13 are not overlapped in the first direction within the boundary of the first through hole 131 such that the direct contact and connection between the first electrode layer 11 and the second electrode layer 12 via the first through hole 131 is avoided, thereby not affecting the liquid leakage detection effect.

In this embodiment, preferably, the first electrode layer 11 and the second electrode layer 12 are respectively arranged at two sides of the first insulating layer 13 and at least partially staggered from each other. In a case where the first detection module 1 is placed horizontally, the first electrode layer 11 and the second electrode layer 12 partially overlap in a vertical direction, or the first electrode layer 11 and the second electrode layer 12 do not overlap at all in the vertical direction.

By staggering the first electrode layer 11 and the second electrode layer 12 from each other in the first direction, the materials used for the first electrode layer 11 and the second electrode layer 12 can be saved. It is only required to ensure that the first electrode layer 11 is partially exposed from the first through hole 131, and the second electrode layer 12 does not cover the first through hole 131.

For example, the first electrode layer 11 only covers the first through hole 131, and the second electrode layer 12 covers the first insulating layer 13 other than the first through hole 131. In this way, without affecting the detection results, the materials used for the first electrode layer 11 and the second electrode layer 12 can be saved to the greatest extent, thereby reducing the cost.

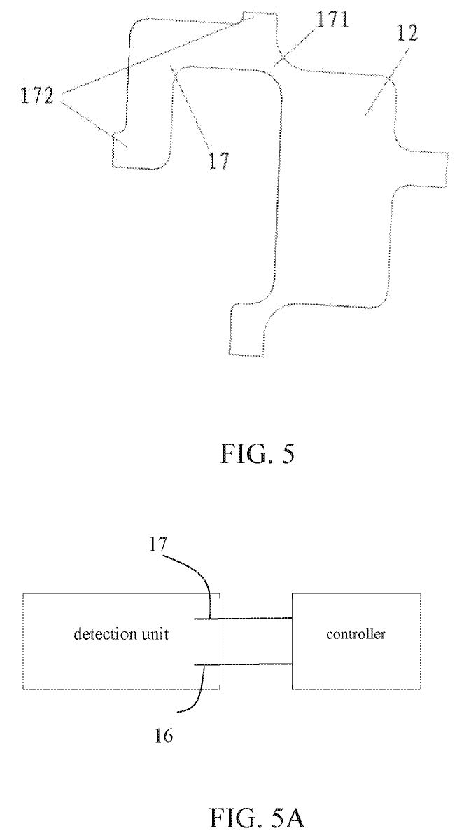

The working principle of the detection unit in this embodiment is as follow: during arrangement, one side, at which the second electrode layer 12 is arranged, of the first detection module 1 faces the scenario to be detected. When there is liquid leakage in the scenario to be detected, the liquid will drip onto the second electrode layer 12 and flow on the second electrode layer 12. When the liquid flows into the first through hole 131, the first electrode layer 11 and the second electrode layer 12 are connected to form a circuit by the liquid, and current flows between the first electrode layer 11 and the second electrode layer 12 such that an external controller as shown in FIG. 5A can obtain information about the presence of liquid leakage in the scenario to be detected.

The detection unit in this embodiment has a simple structure, and the first detection module 1 has a sheet-like structure, and the size of the first detection module 1 can be adjusted according to actual conditions to achieve a wider coverage and adapt to more application scenarios. The first detection module 1 can be arranged in any area of the scenario to be detected.

In the detection unit in this embodiment, the first insulating layer 13 is provided with the first through hole 131, when the liquid dripping onto the second electrode layer 12 flows through the first through hole 131 and contacts the first electrode layer 11, the liquid can connect the first electrode layer 11 and the second electrode layer 12 electrically. When current flowing between the first electrode layer 11 and the second electrode layer 12 is detected from the outside, it can be determined that there is liquid leakage in the detected scenario. Compared with the prior art, since the water-absorbing layer used as an intermediate medium is omitted, the connection between the first electrode layer 11 and the second electrode layer 12 is not affected by the water absorption of the water-absorbing layer, and the failure to trigger an alarm due to leakage of less liquid or a false alarm due to excessive humidity of the air can be avoided.

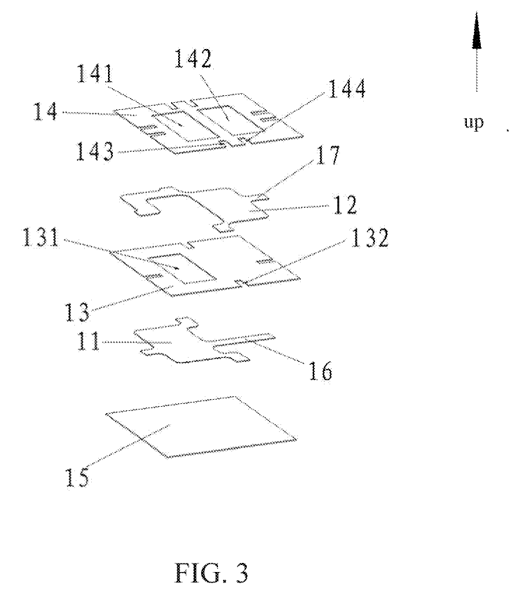

The first direction used herein refers to the direction from bottom to top, as shown in FIG. 3.

In the detection unit in an embodiment of the present disclosure, as shown in FIGS. 1-7, the first detection module 1 further includes a second insulating layer 14 which is arranged opposite to the first insulating layer 13, and the second insulating layer 14 is connected to a side of the second electrode layer 12 away from the first insulating layer 13. The second insulating layer 14 is provided with a second through hole 141 and a third through hole 142 which are spaced apart, the second through hole 141 and the first through hole 131 are arranged correspondingly from top to bottom, and the second electrode layer 12 covers at least part of the third through hole 142.

In this embodiment, the first detection module 1 further includes the second insulating layer 14. The size and material of the second insulating layer 14 are the same as those of the first insulating layer 13 and the detailed description is omitted here. The second insulating layer 14 is arranged opposite to the first insulating layer 13, and the second insulating layer 14 is connected to a side of the second electrode layer 12 away from the first insulating layer 13. In other words, the second insulating layer 14 covers an upper surface of the second electrode layer 12. By providing the second insulating layer 14 covered on the upper side of the second electrode layer 12, the top of the first detection module 1 can be prevented from being electrically conductive.

In this embodiment, the second insulating layer 14 is provided with a second through hole 141 and a third through hole 142, and the second through hole 141 and the third through hole 142 are spaced apart. That is, the second through hole 141 and the third through hole 142 are two independent holes which are not connected to each other and do not interfere with each other. The second through hole 141 is in communication with the first through hole 131. Moreover, the first through hole 131 and the second through hole 141 are arranged correspondingly from bottom to top, so that the first electrode layer 11 can be exposed from the first through hole 131 and the second through hole 141. Thus, the liquid on the upper surface of the second insulating layer 14 can flow to the upper surface of the first electrode layer 11 through the second through hole 141 and the first through hole 131. By providing the third through hole 142 in the second insulating layer 14, the second electrode layer 12 can be exposed from the third through hole 142. That is, the third through hole 142 is formed directly above at least part of the second electrode layer 12.

In the detection unit in this embodiment, the liquid flows on the upper surface of the second insulating layer 14. After the liquid flows to the second through hole 141 and the third through hole 142, the first electrode layer 11 and the second electrode layer 12 form a closed circuit by virtue of the liquid, thereby allowing current to flow between the first electrode layer 11 and the second electrode layer 12.

In this embodiment, preferably, the second electrode layer 12 and the second insulating layer 14 have an overlapping area in which the third through hole 142 is formed; the second through hole 141 is coaxial with the first through hole 131, and the area of the second through hole 141 is not less than the area of the first through hole 131.

That is, in this embodiment, the second through hole 141 and the first through hole 131 cooperatively form a new through hole, and this new through hole and the third through hole 142 together constitute a detection area of the first detection module 1.

In this embodiment, optionally, the shapes of the first through hole 131, the second through hole 141 and the third through hole 142 may be selected according to actual conditions and may be, such as, round, square or waist-shaped.

In the detection unit in an embodiment of the present disclosure, as shown in FIGS. 1-7, the first detection module 1 further includes a third insulating layer 15; the third insulating layer 15 is arranged facing the first insulating layer 13, and the third insulating layer 15 is connected to a side of the first electrode layer 11 away from the first insulating layer 13 and covers the first electrode layer 11.

In this embodiment, the first detection module 1 further includes a third insulating layer 15, the third insulating layer 15 is a base layer, and the size and material of the third insulating layer 15 are the same as those of the first insulating layer 13 and the second insulating layer 14 and will not be described in detail here.

In this embodiment, the third insulating layer 15 is arranged opposite to the first insulating layer 13, and the third insulating layer 15 is arranged on the side of the first electrode layer 11 away from the first insulating layer 13. That is, the third insulating layer 15 is connected to a lower surface of the first electrode layer 11, so as to protect the lower surface of the first electrode layer 11.

In summary, the first detection module 1 includes five functional layers, which are, in order from bottom to top, the third insulating layer 15, the first electrode layer 11, the first insulating layer 13, the second electrode layer 12 and the second insulating layer 14. The first insulating layer 13 and the second insulating layer 14 are provided with the first through hole 131 and the second through hole 141 which are in communication with each other, and the first electrode layer 11 is exposed via the first through hole 131 and the second through hole 141. The second insulating layer 14 is also provided with the third through hole 142, and the second electrode layer 12 is exposed from the second through hole 141.

In the detection unit in an embodiment of the present invention, as shown in FIGS. 1-7, the first detection module 1 further includes a first conductive portion 16 and a second conductive portion 17. The first conductive portion 16 has one end serving as a first wiring end 162 and the other end serving as a first connecting end 161, and the first connecting end 161 is connected to the first electrode layer 11. The second conductive portion 17 has one end serving as a second wiring end 172 and the other end serving a second connecting end 171, and the second connecting end 171 is connected to the second electrode layer 12. In addition, the second conductive portion 17 does not cover the first through hole 131, or the second conductive portion 17 is covered with a fourth insulating layer in order to prevent the first electrode layer 11/the second conductive portion 17 and the first electrode layer 12 directly connect via the first through hole 131 in a normal condition where there is no liquid leakage happened.

In this embodiment, the first detection module 1 further includes the first conductive portion 16 and the second conductive portion 17, and the first conductive portion 16 and the second conductive portion 17 are both made of conductive materials.

The first conductive portion 16 has the first wiring end 162 and the first connecting end 161, the first wiring end 162 is configured to be connected to the outside, and the first connecting end 161 is configured to be electrically connected to the first electrode layer 11. The second conductive portion 17 has the second wiring end 172 and the second connecting end 171, the second wiring end 172 is configured to be connected to the outside, and the second connecting end 171 is configured to be connected to the second electrode layer 12.

In this embodiment, because the first conductive portion 16 is connected to the first electrode layer 11 and the second conductive portion 17 is connected to the second electrode layer 12; accordingly, the first conductive portion 16 is located between the third insulating layer 15 and the first insulating layer 13, and the second conductive portion 17 is located between the first insulating layer 13 and the second insulating layer 14. By providing the conductive portions 16/17, the first detection module 1 can be easily connected to an external controller and the like.

In this embodiment, the first conductive portion 16 and the second conductive portion 17 are both configured as strip-shaped structures. Taking the first conductive portion 16 as an example, the first wiring end 162 and the first connecting end 161 are two ends of the first conductive portion 16.

Further, in order to prevent the second conductive portion 17 from being directly connected to the first electrode layer 11 via the first through hole 131, the second conductive portion 17 needs to offset from the first through hole 131 during arrangement. That is, the second conductive portion 17 does not cover the first through hole 131. Alternatively, by means of covering the second conductive portion 17 with a fourth insulating layer, the second conductive portion 17 can also be prevented from being directly connected to the first electrode layer 11 via the first through hole 131.

Optionally, the material of the fourth insulating layer is the same as that of the first insulating layer 13 and will not be described in detail here.

In the detection unit in an embodiment of the present disclosure, as shown in FIGS. 1-7, a plurality of first wiring ends 162 and a plurality of second wiring ends 172 are provided, and the first wiring ends 162 and the second wiring ends 172 are arranged in one-to-one correspondence, all the first wiring ends 162 are arranged along a peripheral side of the first electrode layer 11 and spaced apart, and all the second wiring ends 172 are arranged along a peripheral side of the second electrode layer 12 and spaced apart.

In this embodiment, in order to facilitate the connection between the first detection module 1 and the external controller, preferably, the first electrode layer 11 includes a plurality of first wiring ends 162, the second electrode layer 12 includes a plurality of second wiring ends 172, and the first wiring ends 162 and the second wiring ends 172 are in one-to-one correspondence. Moreover, all the first wiring ends 162 are arranged along the peripheral side of the first electrode layer 11 and spaced apart, and all the second wiring ends 172 are arranged along the peripheral side of the second electrode layer 12 and spaced apart.

In this embodiment, taking the first electrode layer 11 as an example, when the first electrode layer 11 is provided with a plurality of first wiring ends 162, it may be realized by providing a plurality of first conductive portions 16, each having a first wiring end 162, or by providing a plurality of first wiring ends 162 on each first conductive portion 16, or by a combination of the above two methods.

For example, referring to FIGS. 3 and 5, the second electrode layer 12 is provided with three second conductive portions 17, two of the three second conductive portions 17 are each only provided with one second wiring end 172 and one second connecting end 171 and the other second conductive portion 17 is provided with two second wiring ends 172 and one second connecting end 171.

When one first conductive portion 16 is provided with a plurality of first wiring ends 162, protrusions may be provided on the first conductive portion 16 to form the first wiring ends 162.

In this embodiment, the first wiring ends 162 of the first electrode layer 11 may be arranged with reference to the arrangement of the second electrode layer 12, so the detailed description thereof will be omitted here.

Preferably, the first electrode layer 11 and the second electrode layer 12 are both polygons, such as squares or pentagons.

Further, each side of the first electrode layer 11 is provided with one first wiring end 162, and each side of the second electrode layer 12 is provided with one second wiring end 172, thereby facilitating the wiring connection between the first detection module 1 and an external component such as the external controller.

In this embodiment, when the first detection module 1 has a plurality of first wiring ends 162 and a plurality of second wiring ends 172, a plurality of first detection modules 1 may also be connected in series for use, thereby improving the applicability of the detection unit.

In the detection unit in an embodiment of the present disclosure, as shown in FIGS. 1-7, preferably, any one of the first wiring ends 162 and any one of the second wiring ends 172 do not overlap each other in the first direction. That is, the projections of any first wiring end 162 and any second wiring end 172 on the first insulating layer 13 do not overlap, so as to prevent the first wiring end 162 and the second wiring end 172 from interfering with each other when the first wiring end 162 and the second wiring end 172 are connected to the external components, thereby ensuring the accuracy of a detection result given by the detection unit.

Moreover, any first wiring end 162 and any second wiring end 172 do not overlap each other in the first direction, thereby facilitating the wiring connection operation of operators.

In the detection unit in an embodiment of the present disclosure, as shown in FIGS. 1-7, the first insulating layer 13 is provided with first notches 132 corresponding to the first wiring ends 162; the second insulating layer 14 is provided with second notches 143 corresponding to the first wiring ends 162 and third notches 144 corresponding to the second wiring ends 172.

In this embodiment, as described above, that the first conductive portion 16 is located between the first insulating layer 13 and the third insulating layer 15, and the second conductive portion 17 is located between the first insulating layer 13 and the second insulating layer 14. In order to facilitate the connection of the first wiring ends 162 and the second wiring ends 172 to the external components, the first insulating layer 13 is provided with the first notches 132 corresponding to the first wiring ends 162, and the second insulating layer 14 is provided with the second notches 143 corresponding to the first wiring ends 162 and third notches 144 corresponding to the second wiring ends 172.

In this embodiment, correspondingly, the first notches 132 also correspond to the second notches 143. The first wiring ends 162 are exposed from the first notches 132 and the second notches 143, and the second wiring ends 172 are exposed from the third notches 144.

In this embodiment, the first wiring ends 162 are exposed from the first notches 132 and the second notches 143, and the second wiring ends 172 are exposed from the third notches 144, thereby facilitating the wiring connection operation of operators.

In this embodiment, the shapes of the first notches 132, the second notches 143 and the third notches 144 can be set according to actual needs.

In this embodiment, as described above, any one of the first wiring ends 162 and any one of the second wiring ends 172 do not overlap each other in the first direction, and accordingly, all the second notches 143 and the third notches 144 are also spaced apart. Therefore, in this embodiment, the first notches 132, the second notches 143 and the third notches 144 are arranged to facilitate the connection of the first wiring ends 162 and the second wiring ends 172 to the external components, and also to form the detection area described above.

A conventional sensor 21 for detecting whether there is liquid leakage in a scenario to be detected has a simple function. That is, the conventional sensor 21 can only be used to detect whether there is liquid leakage in the scenario to be detected. In order to solve this problem, as shown in FIGS. 1-9, the detection unit in an embodiment of the present disclosure further includes a second detection module 2, and the second detection module 2 and the first detection module 1 are stacked. The second detection module 2 includes a plurality of sensors 21, each sensor 21 has a detection parameter, and the detection parameters may be the same or different.

For example, the second detection module 2 includes two sensors 21, one of which is a temperature sensor for detecting the temperature information of the detected scenario, and the other is a pressure sensor for detecting the pressure information of the detected scenario.

In this embodiment, the arrangement of the second detection module 2 makes the detection unit be capable of achieving multiple functions, thereby improving the applicability of the detection unit. Moreover, since other detection components for detecting other parameters are not needed, the space utilization rate can be improved.

In the detection unit in an embodiment of the present disclosure, the first detection module 1 and the second detection module 2 are stacked, and preferably, the second detection module 2 is connected to a lower surface of the third insulating layer 15.

In this embodiment, isolating layers are provided on upper and lower sides of each sensor 21, and the isolating layers have the same function as the insulating layers described above.

In this embodiment, when the second detection module 2 is arranged between any two functional layers of the first detection module 1, the upper and lower surfaces of each sensor 21 need to be provided with the isolating layers, and corresponding through holes and notches need to be formed in the isolating layers.

In this embodiment, when the second detection module 2 is stacked below the first detection module 1, only the lower surface of the sensor 21 needs an isolating layer. The third insulating layer 15 serves as the base layer of the first detection module 1 and also as the isolating layer on the upper surface of the sensor 21.

For example, in the detection unit in an embodiment of the present invention, each first detection module 1 has five layers, which are the third insulating layer 15, the first electrode layer 11, the first insulating layer 13, the second electrode layer 12 and the second insulating layer 14 in order from bottom to top. During assembly, the five functional layers are stacked in sequence. The first insulating layer 13, the second insulating layer 14 and the third insulating layer 15 are all square; the first electrode layer 11 and the second electrode layer 12 are both strip-shaped, and the first electrode layer 11 and the second electrode layer 12 are staggered.

In another aspect, the present disclosure further provides a detection device which is formed by splicing a plurality of detection units in sequence. The structure and principle of the detection unit have been described in detail above and will not be repeated here.

According to the detection unit in an embodiment of the present invention, as shown in FIGS. 1-8, in order to adapt to different scenarios, a plurality of detection units can be spliced for use. During splicing, two adjacent first electrode layers 11 are connected by the first wiring ends 162, and two adjacent second electrode layers 12 are connected by the second wiring ends 172.

In this embodiment, by arranging a plurality of first detection modules 1, the detection area can be increased, and the detection unit can adapt to detection scenarios of different shapes, thereby improving the applicability.

In this embodiment, two adjacent first electrode layers 11 are connected by the first wiring ends 162 on the two first electrode layers 11. Optionally, a conductive connection structure, such as a lead wire or a conductive sheet, may be arranged to connect the two first wiring ends 162. Two adjacent second electrode layers 12 may be connected by the second wiring ends 172 on the two second electrode layers 12. Optionally, a conductive connection structure, such as a lead wire or a conductive sheet, may be arranged to connect the two second wiring ends 172.

In this embodiment, in order to avoid the occurrence of blind zones in detection, in the case of a plurality of first detection modules 1, the first detection modules 1 are preferably square.

In this embodiment, all the first conductive portions 16 are arranged along the peripheral sides of the first electrode layers 11 and spaced apart, and preferably, the first wiring ends 162 are arranged along the peripheral sides of the first electrode layers 11 and evenly spaced apart. All the second conductive portions 17 are arranged along the peripheral sides of the second electrode layers 12, and preferably, the second wiring ends 172 are evenly spaced along the peripheral sides of the second electrode layers 12.

For example, referring to FIGS. 1-8, the first detection module 1 is square, the first electrode layer 11 and the second electrode layer 12 are both rectangular, the first electrode layer 11 only covers the first through hole 131, and the second electrode layer 12 only covers the third through hole 142.

The first electrode layer 11 is provided with four first conductive portions 16, and each first conductive portion 16 has a first connecting end 161 and a first wiring end 162. The second electrode layer 12 is provided with three second conductive portions 17, one of the three second conductive portions 17 has two second wiring ends 172 and one second connecting end 171, and each of the other two second conductive portions 17 has a second wiring end 172 and a second connecting end 171.

In this embodiment, after the first detection module 1 is assembled, the first wiring ends 162 and the second wiring ends 172 on the same side are symmetrical about the midline of the first insulating layer 13, so as to facilitate subsequent connection to other first detection modules 1.

In this embodiment, in order to improve the applicability of the detection unit, a plurality of first detection modules 1 are spliced for use, and the two connected first detection modules 1 are connected by the first wiring ends 162 and the second wiring ends 172 on the same side.

In this embodiment, the lower surface of the third insulating layer 15 is connected to the temperature sensor 21 and the pressure sensor 21, and the third insulating layer 15 serves as an isolating layer on the upper surfaces of the temperature sensor 21 and the pressure sensor 21, and the lower surfaces of the temperature sensor 21 and the pressure sensor 21 are connected to another insulating layer which is used as an isolating layer.

In use, the detection units may be fixed to the scenario to be detected by means such as double-sided tape or screws.

In this embodiment, preferably, the first conductive portions 16 and the corresponding first electrode layer 11 are in an integrated structure, and the second conductive portions 17 and the corresponding second electrode layer 12 are in an integrated structure.

In the description of the present disclosure, it should be noted that the orientation or position relationships indicated by the terms such as "up” and "down” are based on the orientation or position relationships shown in the accompanying drawings and are used only for the convenience of describing the present disclosure and simplifying the description, rather than indicating or implying that the device or element referred to must have a specific orientation, be constructed and operated in a specific orientation. Therefore, they should not be construed as limiting the present disclosure. In addition, the terms "first” and "second” are used for descriptive purposes only and are not to be understood as indicating or implying relative importance.

In the description of the invention, it should be noted that, unless otherwise expressly specified and limited, the terms “mount”, “connection” and “communication” shall be understood broadly. For example, they may refer to fixed connection, detachable connection, or integrated connection; they may refer to mechanical connection or electrical connection; they may refer to direct connection/ communication, or indirect connection/ communication by an intermediate medium, or connection/communication within two components. For those of ordinary skill in the art, the specific meanings of the above terms used in the present disclosure can be understood according to specific circumstances. Moreover, in the description of the invention, “a plurality of” means two or more, unless otherwise stated.

The above are only preferred embodiments of the invention and not intended to limit the invention. Any modifications, equivalent substitutions, improvements, etc. made within the spirit and principle of the invention should be included in the scope of the invention.

What is claimed is:

1. A detection unit, comprising: a first detection module, wherein:
the first detection module comprises a first electrode layer, a second electrode layer and a first insulating layer;
the first electrode layer, the first insulating layer and the second electrode layer are stacked in sequence in a first direction, and the first electrode layer and the second electrode layer are at least partially staggered in the first direction; and
the first insulating layer defines a first through hole, the first electrode layer covers at least part of the first through hole, and the second electrode layer is offset from the first through hole.

2. The detection unit according to claim 1, wherein the first detection module further comprises a second insulating layer which is connected to a side of the second electrode layer away from the first insulating layer; and
the second insulating layer defines a second through hole and a third through hole which are spaced apart, the second through hole and the first through hole are arranged correspondingly from top to bottom, and the second electrode layer covers at least part of the third through hole.

3. The detection unit according to claim 2, wherein the first detection module further comprises a third insulating layer; and
the third insulating layer is connected to a side of the first electrode layer away from the first insulating layer and covers the first electrode layer.

4. The detection unit according to claim 2, wherein the first detection module further comprises a first conductive portion and a second conductive portion;
the first conductive portion has one end serving as a first wiring end and another end serving as a first connecting end which is connected to the first electrode layer;
the second conductive portion has one end serving as a second wiring end and another end serving a second connecting end which is connected to the second electrode layer; and
the second conductive portion is offset from the first through hole, or, the second conductive portion is covered with a fourth insulating layer.

5. The detection unit according to claim 4, wherein a plurality of said first wiring ends and a plurality of said second wiring ends are provided, and the first wiring ends and the second wiring ends are arranged in one-to-one correspondence, the first wiring ends are arranged along a peripheral side of the first electrode layer and spaced apart from each other, and the second wiring ends are arranged along a peripheral side of the second electrode layer and spaced apart from each other.

6. The detection unit according to claim 5, wherein any one of the first wiring ends and any one of the second wiring ends do not overlap each other in the first direction.

7. The detection unit according to claim 6, wherein the first insulating layer is provided with first notches corresponding to the first wiring ends; and
the second insulating layer is provided with second notches corresponding to the first wiring ends and third notches corresponding to the second wiring ends.

8. The detection unit according to claim 1, further comprising a second detection module, wherein the second detection module and the first detection module are stacked in the first direction; and
the second detection module comprises a plurality of sensors, each sensor has a detection parameter.

9. The detection unit according to claim 8, wherein the second detection module further comprises isolating layers which cover the sensors.

10. A detection device, comprising a plurality of said detection units according to claim 1.

11. A detection unit, comprising: a first detection module, wherein:
the first detection module comprises a first electrode layer, a second electrode layer and a first insulating layer;
the first electrode layer, the first insulating layer and the second electrode layer are stacked in sequence in a first direction; and
the first insulating layer defines a first through hole, the first electrode layer covers at least part of the first through hole, and the second electrode layer at least partly exposes the first through hole such that liquid dripping onto the second electrode layer can flow through the first through hole to contact the first electrode layer.

12. The detection unit according to claim 11, wherein the first electrode layer only covers the first through hole, and the second electrode layer covers the first insulating layer other than the first through hole; or
no overlap is formed within a boundary of the first through hole between projections of the first electrode layer and the second electrode layer on the first insulating layer.

13. The detection unit according to claim 11, wherein the first detection module further comprises a second insulating layer which is connected to a side of the second electrode layer away from the first insulating layer; and
the second insulating layer defines a second through hole, and the second through hole and the first through hole are at least partly overlapped with each other in the first direction.

14. The detection unit according to claim 13, wherein the second insulating layer defines a third through hole, the second through hole and the third through hole are spaced apart, and the second electrode layer covers at least part of the third through hole.

15. The detection unit according to claim 14, wherein the second through hole is coaxial with the first through hole, and the area of the second through hole is not less than the area of the first through hole; and
the third through hole is formed in an area where the second electrode layer and the second insulating layer overlap.

16. The detection unit according to claim 13, wherein the first detection module further comprises a third insulating layer which is connected to a side of the first electrode layer away from the first insulating layer.

17. The detection unit according to claim 11, wherein the first detection module further comprises a first conductive portion and a second conductive portion;
the first conductive portion is connected to the first electrode layer and configured to electrically connect the first electrode layer to an external component;
the second conductive portion is connected to the second electrode layer and configured to electrically connect the second electrode layer to the external component.

18. The detection unit according to claim 11, further comprising a second detection module, wherein the second detection module and the first detection module are stacked in the first direction, and the second detection module comprises at least one sensor.

19. The detection unit according to claim 18, wherein the second detection module further comprises an isolating layer which covers a side of the sensor away from the first detection module.

20. A detection device, comprising a plurality of said detection units according to claim 11, the plurality of said detection units being spliced together in another direction which is perpendicular to the first direction.
